(19) United States
(12) Patent Application Publication
(10) Pub. No.: US 2009/0158342 A1
(43) Pub. Date: Jun. 18, 2009

(54) APPARATUS AND METHOD FOR GENERATING CONTENT PROGRAM RECOMMENDATIONS

(75) Inventors: Kevin C. Mercer, Wantage (GB); Sandra C. Gadanho, Reading (GB); Craig C. Watson, Southampton (GB)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/958,694

(22) Filed: Dec. 18, 2007

(51) Int. Cl. G06F 3/00

(52) U.S. Cl. 725/46

(57) ABSTRACT

An apparatus for generating content program recommendations comprises a meta-data processor (209) which provides characterising data for a plurality of content programs. A context processor (215) provides first context data for a user and a time window processor (213) determines a content consumption time window for the user in response to the first context data. The content consumption time window represents an estimated time window available to the user for consuming content. A recommendation unit (207) then generates a content program recommendation comprising in response to the content consumption time window and the characterising data. The invention may be particularly advantageous for mobile content program distribution services, such as a mobile television service, as recommendations may be generated that take into account the particular characteristics of the mobile user environment. Specifically, the recommendation can take into account the increased probability of a disruption to the consumption experience caused by external factors.

### FIELD OF THE INVENTION

The invention relates to a method and apparatus for generating content program recommendations, and in particular, but not exclusively to generation of recommendations for television programs of a mobile television service.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content, personalizing services etc.

As an example, television recommender systems are becoming a popular way to help people navigate a large and increasing number of program options in order to find the programs that fit their individual (or family group) preferences. For example, Digital Video Recorders (DVRs) or Personal Video Recorders (PVRs) which comprise functionality for providing recommendations of television programs to the user based on user preferences are becoming increasingly popular.

Furthermore, there is currently a trend towards providing program content on an increasing number of different devices. For example, the popularity of mobile devices, such as mobile phones, has led to the desire to provide program content on such devices. Accordingly, a number of different systems and standards are being developed in order to provide e.g. television services on a mobile device (such as the Digital Video Broadcast—Handheld (DVB-H) service).

Although, the amount of television content available to mobile devices through these systems is currently relatively limited, it is likely that a situation similar to conventional television systems will arise in the future. Thus, it is likely that a mobile user in the future will have access to a very large number of channels and programs. For example, it is possible that each individual user may be provided with access to hundreds of broadcast channels providing thousands of television programs per day. Such a massive provision of content may overwhelm many users thereby preventing them from fully benefiting from the available technology and content. Such disadvantages may be more significant for the mobile television domain where e.g. content navigation and discovery is likely to be more difficult or cumbersome due to the reduced information display capabilities typically associated with mobile devices.

Also, the content consumption experience in a mobile domain is typically substantially different than for conventional static consumption experiences. For example, whereas a conventional television viewing experience can normally be adapted to fit the specific television programs, the mobile television viewing experience is typically much more controlled by external restrictions or conditions. In particular, a mobile television viewing experience is much more likely to be interrupted by external factors. For example, whereas a convention television viewing experience is normally at a user's home and at a time when a user can control when to stop watching the television, viewing patterns are for mobile television highly controlled by the external conditions for the user. For example, the user may often be interrupted when the current viewing opportunity ceases, (e.g. a user watching mobile television during a train commute will have to stop watching when the train reaches the user's destination).

In such cases providing program recommendations based on potential interest alone tends to be suboptimal as it can result in e.g. the user often having to stop midway through an interesting program or the user having to find additional content to fill the remaining time after an initial recommendation has finished. This can lead to a reduced user experience and dissatisfaction for the viewer.

United States patent application US20030172381 A1 discloses a system wherein an audiovisual program can be generated by editing which can be processed such that the duration of the generated program depends on a time available to the user to watch the program. The editing can specifically generate a program by combining small segments of a program with the total number of segments used for the program depending on the desired program length.

However, although the disclosed approach may generate a more flexible system, it also has some disadvantages. For example, the system requires that small segments of content are provided such that these can be combined into programs. Thus, an entirely different content generation, provision and distribution approach to that of conventional television is required thereby adding substantial complexity to the system and avoiding operational synergy and backwards compatibility with conventional television systems. Also, the approach is only appropriate for some content programs with natural segment breaks, such as news or magazine programs, whereas it is unsuitable for many other content programs, such as dramas or programs with narratives. Thus, the applicability of the described system is relatively limited.

Furthermore, the approach requires complex editing to be performed at the individual device thereby not only requiring substantial computational power but also requiring substantial memory resource in order to store the segments that may be used to generate the program. Such an approach is accordingly unsuitable for mobile devices which are typically characterised by having relatively low amounts of computational and memory resource. Furthermore, the required editing would require substantial computation which may significantly affect power consumption and thus substantially reduce battery life for the mobile device.

Hence, an improved approach would be advantageous and in particular a system allowing increased flexibility, reduced resource requirements and usage, improved suitability for mobile content consumption, improved performance, increased compatibility with other systems and/or an improved user experience would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided method of generating content program recommendations, the method comprising: providing characterising data for a plurality of content programs; providing first context data for a user; determining a content consumption time window for the user in response to the first context data; and generating a content program recommendation comprising at least one content program of the plurality of content programs in response to the content consumption time window and the characterising data.

The invention may allow an improved user experience and may allow improved content consumption. In particular, the invention may allow an improved user experience for disruptive and/or dynamically changing content consumption environments, and may specifically allow an improved user experience for a television or radio service for mobile devices.

A flexible content consumption experience can be provided. For example, an automated adaptation of content recommendation and consumption to the likely consumption time constraints for the user can be achieved.

The improved performance and/or experience may be achieved by a system allowing practical and/or facilitated implementation and/or low complexity and/or operating costs. In particular, the improved user experience may be achieved with low computational and/or memory requirements.

Each content program may be accessible only as a full undivided content program. The invention may provide an improved user experience for conventional content programs, such as television or radio programs, and may allow an improved compatibility with other content distribution systems, such as conventional television or radio broadcast systems. In particular, no separate or additional content generation or manipulation is typically needed to achieve the described advantages.

According to another aspect of the invention, there is provided an apparatus for generating content program recommendations, the apparatus comprising: means for providing characterising data for a plurality of content programs; means for providing first context data for a user; means for determining a content consumption time window for the user in response to the first context data; and means for generating a content program recommendation comprising at least one content program of the plurality of content programs in response to the content consumption time window and the characterising data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a user equipment for a cellular communication system in accordance with some embodiments of the invention; and

FIG. 3 illustrates an example of a flowchart for a method of generating content program recommendations in accordance with some embodiments of the invention.

### DETAILED DESCRIPTION OF SOME EMBODIMENTS OF THE INVENTION

The following description focuses on embodiments of the invention applicable to a mobile television service provided by a cellular communication system and in particular to an DVB-H (Digital Video Broadcasting—Handheld) service for a Global System for Mobile communication (GSM) or Universal Mobile Telecommunication System (UMTS) cellular communication system. However, it will be appreciated that the invention is not limited to this application but may be applied to many other applications including for example other content types (e.g. radio), services and/or communication systems.

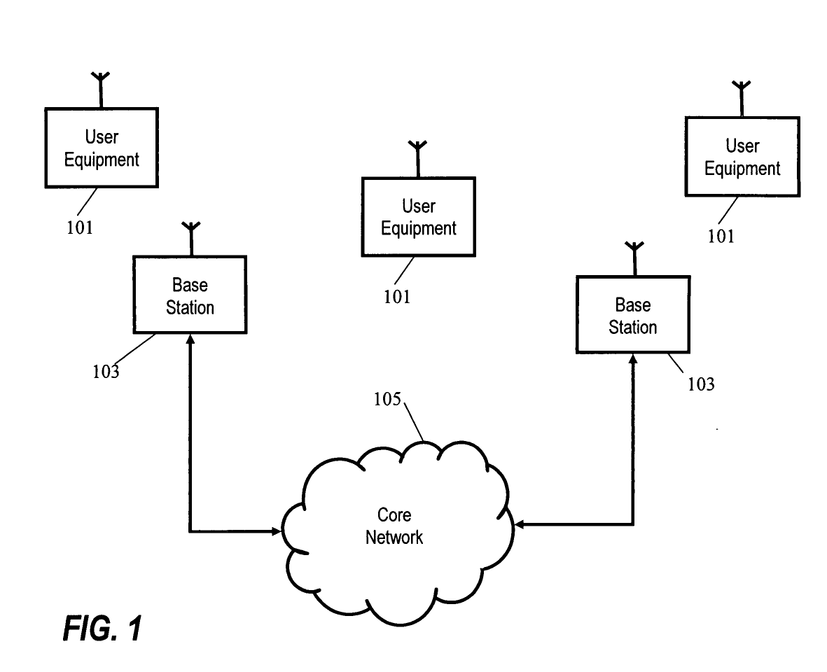

FIG. 1 illustrates an example of a cellular communication system in accordance with some embodiments of the invention.

The cellular communication system is a GSM/UMTS cellular communication system which supports a plurality of user equipments. In the example three user equipments 101 supported by two base stations 103 are shown but it will be appreciated that a typical cellular communication system will support a large number of user equipments and base stations. A user equipment may be any communication entity capable of communicating with a base station (or access point) over the air interface including e.g. a mobile phone, a mobile terminal, a mobile communication unit, a remote station, a subscriber unit, a 3G User Equipment etc.

The base stations 103 are coupled to a GSM/UMTS core network 105 which represents all aspects of the fixed segment of the GSM/UMTS communication system including other base stations, Radio Network Controllers, Mobile Switching Centres etc as will be well known to the person skilled in the art.

In the example, the system may provide a television service to the users of the user equipments 101 and specifically a DVB-H compliant service may be provided. Thus, in the system each of the base stations 103 may transmit a television broadcast signal comprising real time broadcast content programs which in the example are television programs. Each of the user equipments 101 may comprise functionality for receiving the DVB-H signals and to present the television programs to the user.

In the specific example, the DVB-H broadcast transmissions are made by the base stations 103. In one embodiments, the base stations 103 used for DVB-H broadcasts may be separate and independent of base stations used for normal cellular communication systems. Indeed, in some embodiments, the DVB-H broadcast equipment may be largely separate from the conventional cellular communication system infrastructure (although the core equipment will typically interface for billing and peripheral applications, such as like SMS voting on DVB-H programs etc).

In the following, embodiments of the invention will be described which seek to enhance the user experience for mobile content consumption by providing personalized content recommendations that are created considering the dynamically changing temporal aspects of the user's context, in addition to their more general content preferences. In particular, improved personalised recommendations of television programs are used to enhance the mobile television user experience.

In the system, user preferences may be generated based on implicit or explicit user feedback mechanisms and these user preferences are used to generate a matched list of programs considered to be of particular interest to the user. In addition, the generated recommendations also take into account the duration of the individual programs and an estimated time window the user has available to watch the recommended programs.

Thus, when a user requests a content recommendation, an estimate of the user's viewing opportunity will be made and a suitable viewing time window will be determined. The system then proceeds to generate content recommendations that not only are of interest to the user (in accordance with the user preferences) but which also have a broadcast duration that matches the estimated viewing time window.

Thus, the system seeks to provide an efficient recommendation function that can provide recommendations which are not only of relevance but which are also contextually suited to the user's current viewing opportunity.

In the following an example will be described wherein the recommendation functionality is located in the individual user equipment 101. However, it will be appreciated that in other embodiments, the recommendation functionality may be located elsewhere, such as in a central recommendation server being part of the fixed network of the communication system.

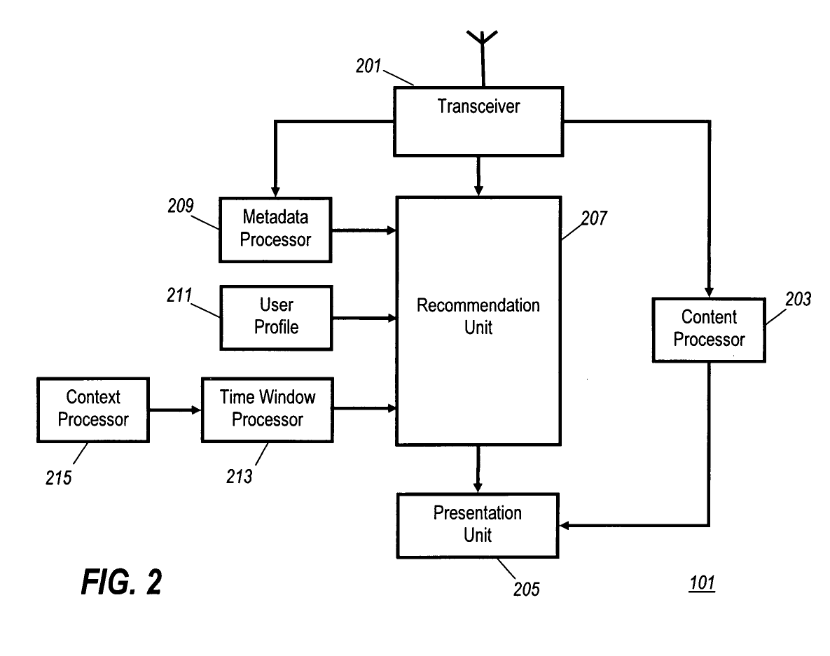

FIG. 2 illustrates elements of a user equipment 101 comprising functionality for supporting a DVB-H mobile television service and for providing user recommendations for television programs.

The user equipment 101 comprises a transceiver 201 which comprises the required or desired functionality for supporting communications over the air interface of the cellular communication system. Specifically, the transceiver 201 can receive DVB-H transmissions from the base stations 203.

The transceiver 201 is coupled to a content processor 203 which is fed the received television data. The content processor 203 is coupled to a presentation unit 205 which comprises functionality for controlling a user interface (not shown) of the user equipment 101. Specifically the presentation unit 205 can control a visual display and a loudspeaker or headphone output of the user equipment 101 in order to provide a presentation of received television programs to the user. The content processor 203 also comprises memory for storing individual television programmes.

The user equipment 101 furthermore comprises a recommendation unit 207 which is coupled to the transceiver 201 and to the presentation unit 205. The recommendation unit 207 is capable of generating content program recommendations which in the example are television program recommendations for the user of the user equipment 101.

In the example, the recommendations are generated based on received characterising data for the available television programs and the recommendation unit 207 is accordingly coupled to a meta-data processor 209 which is further coupled to the transceiver 201. In the system, the base stations 103 not only transmit the television programs themselves but also transmit meta-data that characterises the upcoming television programs. For example, the base stations 103 can transmit an electronic program guide (EPG) which specifies transmission times of upcoming programs and provides descriptions of the programs. This data is received by the meta-data processor 209 and provided to the recommendation unit 207.

The recommendations are furthermore based on user preferences for different content and accordingly the recommendation unit 207 is coupled to a user profile 211 which comprises the user's preference data.

In the system, the generated recommendations are also based on an estimation of the user's viewing opportunity. Accordingly, the recommendation unit 207 is coupled to a time window processor 213 which is arranged to determine a content consumption time window for the user.

The determination of the content consumption time window by the time window processor 213 is based on context data for the user and accordingly the time window processor 213 is coupled to a context processor 215 which is arranged to determine context data and provide this to the time window processor 213.

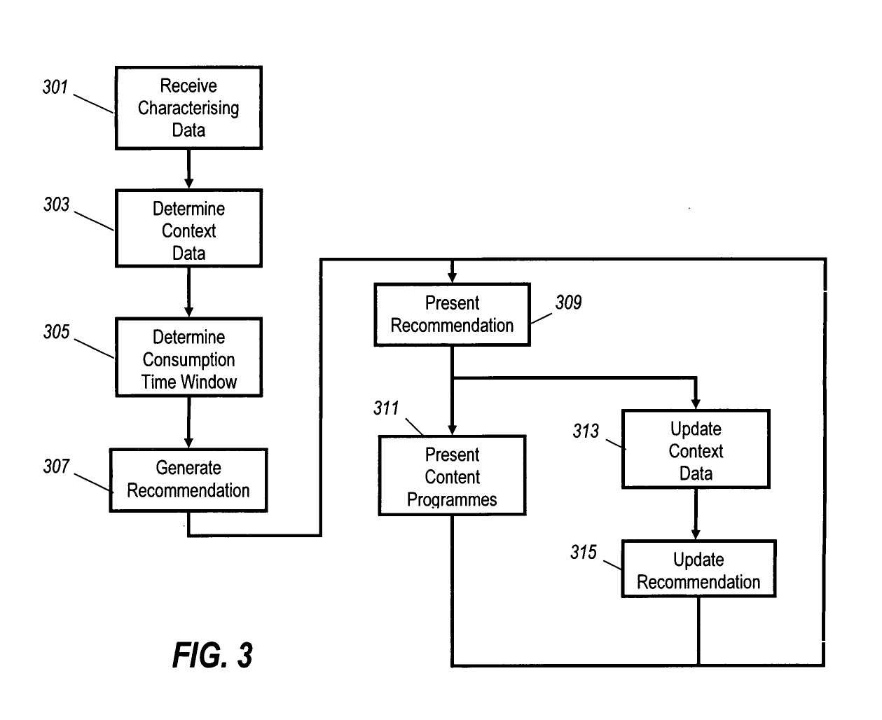

The operation of the user equipment 101 of FIG. 2 will be described with reference to FIG. 3 which shows a method of generating recommendations in accordance with some embodiments of the invention.

The method starts in step 301 wherein the user equipment 101 receives characterising data for a number of upcoming television programs. In the example, the transceiver 201 receives an EPG which includes the transmission times as well as meta-data that describes the television programs. The meta-data may for example include a description of each television program with an indication of the genre, topic, involved people (e.g. actors, presenters, athletes) etc. the EPG is fed to the meta-data processor 209 which proceeds to extract the meta-data and transmission times and feed this information to the recommendation unit 207. The meta-data processor 209 can also provide duration information for the content programs. The duration of a specific television program can be provided directly as a duration time or can be indirectly represented by a start time and/or stop time of the transmissions.

In the specific example, the content programs considered by the recommendation unit 207 include real-time broadcast television programs as well as broadcast television programs that have been temporarily stored in the content processor 203. However, it will be appreciated that in other embodiments, other types of content programs may be considered.

For example, the content source can be any content source that delivers content of a temporal nature, such as audio or video. Also, in many systems, including mobile environments, such content sources may include a mixture of broadcast, on-demand and locally cached content, all of which will be available for playback to the user via various interfaces on the device.

Thus, in step 301 the meta-data processor 209 generates data describing both the content and the transmission characteristics for each content program and provides this data to the recommendation unit 207.

Step 301 is followed by step 303 wherein the context processor 215 proceeds to determine context data for the user.

Step 303 is followed by step 305 wherein the context data is fed to the time window processor 213 which uses it to determine a content consumption time window for the user.

It will be appreciated that in different embodiments, different context data may be used and the time window processor 213 may use different algorithms and approaches to determine the consumption time window.

The context processor 215 can e.g. continually monitor context inputs to generate content data. For example, the context processor 215 can comprise in real-time clock that continually provides the current time. As another example, the context processor 215 can comprise location estimation functionality that continuously generates a location estimate for the user equipment 101. For example, the user equipment 101 can include a built-in GPS receiver which continuously provides a location estimate. Accordingly, the context processor 215 can provide current context data upon request from the time window processor 213.

Alternatively or additionally, the context processor 215 can generate or retrieve context data specifically in response to receiving a request from the time window processor 213. E.g., when a recommendation is requested by the user, the recommendation unit 207 can request a consumption time window from the time window processor 213 which then can access the context processor 215 to request current context data.

When receiving such a request, the context processor 215 can e.g. access other applications to retrieve context data. As an example, the user equipment 101 may comprise functionality for executing a calendar or time management application for the user. The context processor 215 can interface with this application to retrieve context information for the user. Such context information can for example include an indication of an upcoming appointment registered in the calendar or time management application.

In the specific example, the context processor 215 in step 303 generates context data that comprises a current time, a current location estimate for the user equipment 101 cas well as any pertinent appointment data retrieved from a calendar application.

This data is fed to the time window processor 213 which in step 305 proceeds to analyse the context data in order to estimate the consumption time window for the user. Thus, the time window processor 213 estimates the duration of the current content consumption opportunity.

It will be appreciated that the content consumption time window may reflect any parameter or characteristic which provides a time constraint on the user's content consumption. In particular, the consumption time window may be given as an estimated stop time for the user's consumption. Thus, in many embodiments, the content consumption time window will have a duration from the current time until an estimated stop time.

However, it will be appreciated that in other embodiments, both a start time and a stop time can be estimated such that the consumption time window may be a window estimated to begin at a given point in the future. It will also be appreciated that the content consumption time window need not be explicitly given by one more specific time instants but may e.g. be provided as a relative time measure and/or as a non-specific (fuzzy) time instant. For example, a start and/or stop time for the consumption time window may be given as a time instant and an associated variance and/or as a time instant probability distribution.

In some embodiments, the time window processor 213 can determine the consumption time window by evaluating predetermined and/or manually inputted data. For example, a user may manually create a number of different rules for the time window processor 213, such as e.g. a rule that specifies that within a given geographical area and time window, any initiated content consumption will terminate at specific time instant. For example, a commuter typically travelling on a train between 7.30 and 8.30 on a weekday can input rules specifying that any content consumption begun between 7.30 and 8.30 on a weekday is expected to stop at 8.30.

Alternatively or additionally, the time window processor 213 can determine the consumption time window based on a previous content consumption behaviour of the user.

E.g., the time window processor 213 may continually monitor the consumption behaviour of the user when watching television programs. For example, the time window processor 213 can store location estimates and times associated with television viewing. When a recommendation is requested, the time window processor 213 can retrieve the current context data and compare this to stored context data for previous consumption sessions. If one or more suitable matches are found, the current consumption stop time is estimated as the average stop time for the matching previous sessions.

Specifically, whenever a user watches a television program, the user equipment 101 may determine content consumption characteristics and consumption context data associated therewith. E.g. the time window processor 213 can store the start time, stop time and a location estimate for each viewing session.

When the time window processor 213 then receives a request for a determination of a consumption time window, it can search through the stored characteristics to find one or more matching previous viewing sessions. For example, it may retrieve the stop time information for all stored sessions that include the current time of day and is within a predetermined distance of the current location.

The time window processor 213 can then proceed to determine the consumption time window in response to the retrieved content consumption characteristic. For example, the stop time for the time consumption window may be determined as the average stop times for the matching sessions.

It will be appreciated that instead of storing data for all viewing sessions, the time window processor 213 may store combined or average viewing session data generated from a plurality of viewing sessions.

Alternatively or additionally, the time window processor 213 may consider appointment data retrieved from a calendar or time management application. Thus, static data such as calendar entries directly or indirectly indicating content consumption opportunities (e.g. travel agendas, lunch breaks, activity etc) are used to generate the consumption time window. As a specific example, if the calendar data indicates that there is an appointment which precedes the estimated stop time determined from previous sessions, the stop time may instead be set on the basis of this appointment.

It will be appreciated, that a more sophisticated implementation of the time window processor 213 could use machine learning techniques to monitor viewing patterns over a period a time to synthesize a model of user viewing opportunities that allows a consumption time window estimate to be generated based on known past behaviour.

Furthermore, the accuracy of such model can be enhanced by incorporating contextual cues that could help calibrate the model against actual user activity. For example, it would be possible to determine via machine learning techniques that the user views content for 30-60 minutes between 5-6 pm every weekday evening (corresponding to their commute home). By incorporating contextual information (e.g., via GPS) that indicates which of two possible bus routes they are taking, it may be possible to increase the accuracy of the estimate by enhancing the model to determine that if the user caught bus A then the content consumption time window is likely to be 30 ±3 minutes and if they caught bus B the content consumption time window is likely to be 60 minutes ±5 minutes due to a longer route for this bus.

In some embodiments, the context processor 215 may furthermore access an external server to obtain context data that cannot readily be derived from information available at the user equipment 101. For example, the context processor 215 may access a remote traffic information server to obtain data indicative of the current traffic conditions. Thus, this traffic information data can be used by the time window processor 213 to more accurately assess the available time consumption window.

Thus, the determination by the time window processor 213 can incorporate supplemental data from external services that can be used to enhance the accuracy of its consumption opportunity determination. For example variations the consumption time window associated with road or rail commuting can be assessed from web based traffic monitoring services or rail schedule monitoring services.

The context processor 215 or the time window processor 213 can for example be explicitly made aware of the users travel route or can deduce this based on the location estimates and previous behaviour. It can then access traffic data services to obtain traffic data relevant to this route. Hence, if a traffic jam is known to exist on the expected travel route for the user, the estimated content consumption time window can be increased accordingly.

The estimated content consumption time window is then fed to the recommendation unit 207 which in step 307 proceeds to generate a content program recommendation which includes recommendations of one or more television programs. The recommendation unit 207 generates the recommendation in response to the content consumption time window and the characterising data received from the meta-data processor 209.

Specifically, the recommendation unit 207 can proceed to generate a recommendation for one or more television programs that have a duration suitable for the current consumption time window. For example, the recommendation unit 207 may simply scan through the meta-data received from the meta-data processor 209 to find a television program that finishes shortly before the estimated stop time for the consumption time window.

In some embodiments, the recommendation unit 207 may comprise a simple recommender function which does not personalise the generated recommendations but simply recommends the same content to all users based on a manually entered viewer rating or a manual rating provided by an operator ( a “critic's choice” option).

However, in the specific example, the recommendation unit 207 determines the recommendation in response to the user's content preferences received from the user profile 211. As a simple example, for each program, a user preference value may be assigned depending on user preference assigned to matching category identified by a match between the meta-data for the program and meta-data for the content categories of the user profile 211. As a simple example, the recommendation unit 207 may simply proceed to generate the recommendation as a recommendation of the television program that has the highest assigned user preference and which finishes within a time interval of, say, five minutes preceding the estimated consumption stop time.

It will be appreciated that in many embodiments, the recommendation unit 207 may comprise more complex functionality and may in particular comprise a complex recommender function which is arranged to generate recommendations that closely match the user's preferences. It will be appreciated that many different recommender methods and algorithms will be known to the person skilled in the art and that any of these may be used without detracting from the invention.

In order to provide a personalized content recommendation, the user equipment 101 first captures a representation of the user's content preferences by requesting the user to directly (explicitly) specify his preferences and/or by automatically (implicitly) generating the preferences from an analysis of the user's viewing behaviour. The preferences are stored in the user profile 211 and then used by the recommendation unit 207 to generate personalized recommendations from the available television programs.

The recommendations may be generated using content based techniques (which rely on analysis of content description meta-data received from the meta-data processor 209) or collaborative filtering techniques (that rely on analysis if content ratings made by a group of users) or possibly by a combination of these techniques.

The recommendation unit 207 does not only generate the recommendations based on the user preferences but also takes into account the content consumption time window determined by the time window processor 213. In particular, the duration of the different television programs is taken into account by the recommendation unit 207. Thus, the meta-data processor 209 can provides a duration indication for each program, e.g. given as the start time and/or the stop time for the program. These parameters are then taken into account when generating the recommendations. For example, for real-time system wherein content programs are watched at the time of broadcast (i.e. where no storage of television programs is used) the recommendation unit 207 may exclude all television programs that do not fall within the consumption time window.

For a system wherein television programs may be stored at the user equipment 101, the recommendation unit 207 may for example start by excluding all television programs that have a duration longer than the determined consumption time window and/or are broadcast after this window.

In the specific example, the recommendation unit 207 specifically seeks to provide a recommendation for one or more television programs that have a duration which corresponds to the determined consumption time window. For example, the recommendation unit 207 may consider only programs that are shorter than the determined consumption time window, such that they can be watched in their entirety. The selection between these programs may be in response to the user's content preferences and may also take the duration into consideration. For example, a combined preference value may be determined for each qualifying television program with the preference value comprising a contribution from the content preference associated with the television program and a contribution reflecting how closely the duration of the television program matches the available consumption time window.

In the specific example, the generation of the recommendations by the recommendation unit 207 is performed as a two-stage process.

Firstly, the recommendation unit 207 executes a recommendation algorithm that is based on the content preferences stored in the user profile 211. Specifically, the recommendation unit 207 determines a content preference value for each television program. The output of this recommendation process is a list of recommended television programs (possibly associated with a confidence measure indicating the recommender's confidence in the recommendation).

Secondly, the recommendation unit 207 can proceed to modify the generated content preference values to generate a preference value for each program. This modification is dependent on how well the individual television programs match the determined consumption time window.

For example, for stored television programs, the duration of each television program may be compared to the duration of the consumption time window and the content preference value may be scaled according to how well these match. E.g., the preference content value for a television program which substantially exceeds the available consumption time window can be scaled by a very low scale factor whereas a television program having a duration that closely matches (but is slightly shorter than) the available consumption time window will be scaled by a relatively high scale factor.

It will be appreciated that the modifications applied to the content preference values may be designed to suit the specific preferences and requirements for the individual embodiment. For example, in some embodiments the scale factor may be very low (or even zero) for any television program that exceeds the consumption time window in order to substantially reduce the probability of recommending a television program that the user is unlikely to be able to watch to the end.

It will also be appreciated, that the modification applied to the content preference values may depend on characteristics of the individual television program. For example, completely different scaling factors (as a function of the match between the program duration and the consumption time window) may be used depending on whether the television program is e.g. a film or a news program thereby reflecting that the inconvenience of missing the end of a recommended television program can be substantially different for different types of a programs (e.g. it is typically substantially more frustrating to miss the end of a film than of a news program).

Following the modification, the recommendation unit 207 can simply proceed to select one more television programs based on the resulting preference values. As a simple example, the recommendation unit 207 may simply select a recommendation of the television program that has resulted in the highest preference value. Thus, the television program(s) included in the generated recommendation is (are) selected on the basis of both content preference values, durations of the programs and the determined consumption time window.

In some embodiments, the content preference values may also be determined in response to the context data. For example, the content preference values may be dependent on a current time and/or a current location of the user equipment. E.g., the user profile 211 can reflect that the user has different preferences for different times of the day or week and/or different preferences for different locations.

For example, the user preference for news may be high early in the morning and during weekdays whereas the user preference for films is high in the evenings. When retrieving the content preference values, the recommendation unit 207 may specifically retrieve the preferences that are stored for the time of day corresponding to the current time. As another example, the user profile 211 may reflect that the uses preference for films is high when the user within a specific geographic area (e.g. corresponding to his home) whereas it is low outside this area. By retrieving content preference values in response to the current location estimate such preferences may be accurately reflected in the generated recommendations.

In some embodiments and scenarios, the recommendation unit 207 may generate a recommendation for a single television program or for a plurality of alternative (simultaneous) programs. However, in other embodiments or scenarios, the recommendation unit 207 may generate a content program playlist which comprises a sequential list of content programs. Thus, rather than merely recommending a single program that can be watched during the consumption time window, the recommendation unit 207 may generate one or more playlists that provides a sequence of programs which fill out the consumption time window.

For example, following the initial determination of content reference values for each television program, the recommendation unit 207 can proceed to combine these television programs into playlists. The playlists are generated taking into account both the duration of the programs, the associated content preference values and the available consumption time window. E.g. the recommendation unit 207 can generate a playlist comprising a plurality of television programs having a maximised combined content preference value under the constraint that the combined duration must match the time consumption window within a given margin.

Thus, the playlists are created to meet both availability restrictions and to maximize the likelihood of the proposed content matching the user preferences.

In some embodiments, the recommendation processor 207 may generate the playlists in response to content category preference values for different content categories where the content category preference value for a content program is dependent on the location of the content program in the recommendation playlist.

For example, different content categories may be associated with different preferences for different locations in the playlist. Specifically, a content category that includes content which is predominantly narrative (such as dramas or films) may have a higher preference at the beginning of a playlist than at the end of the playlist. Similarly, a content category that includes content which is predominantly characterised by comprising a number of relatively independent sections (such as magazine type programs or news programs) may have a higher preference at the end of a playlist than at the beginning of the playlist. Such preference variations can thus indicate that the inconvenience of missing the end of a television program is significantly higher for e.g. a narrative style program than e.g. for a magazine style program.

The recommendation unit 207 can accordingly for each television program determine which category it belongs to. When generating the playlist the contribution of the preference value for this program to the combined preference value for the whole playlist can accordingly be modified depending on whether the television program is included towards the beginning of the playlist or towards the end of the playlist.

Accordingly, when selecting the last program of the playlist, the recommendation unit 207 may prioritise a magazine type program much higher than other types of programs as it can typically be terminated before the end without a major impact on the viewing experience.

Step 307 is followed by step 309 wherein the generated recommendation (e.g. playlist) is fed to the presentation unit 205 which proceeds to present it to the user. In addition to the recommendation, an indication of the associated duration may also be provided allowing the user to check the duration inferred by the system and eventually manually correcting it if desired.

Step 309 is followed by step 311 wherein the user equipment 101 proceeds to present a selected television program or sequence of television programs if a playlist is selected. Specifically the presentation unit 205 can in response to a user selection retrieve the appropriate television programs from the content processor 203 and present them to the user via a suitable display.

In some embodiments, step 309 is also followed by step 313 which may run concurrently with step 311. In step 313, the user equipment 101 continues to determine context data during the consumption time window. In particular, the context processor 215 may continue to provide a location estimate to the recommendation unit 207.

Step 313 is followed by step 315 wherein the recommendation unit 207 may update the provided recommendations during the content consumption time window. This update is performed in response to the context data determined during the consumption time window. For example, if the location estimate indicates that the user is likely to reach his destination earlier than expected, the stop time for the consumption time window may be modified and accordingly the generated recommendation may be changed. After step 315 or step 311 the method can return to step 309 wherein the updated recommendation is presented to the user.

Thus, the time window processor 213 may specifically be able to dynamically update the estimated consumption time window depending on context data updates. The recommendation unit 207 can then re-examine the playlist and can if required update this to reflect the modified time window.

As an example, the recommendation unit 207 may based on an estimated 25 ±2 minute time window have recommended a play-list consisting of:
A 10 minute news headline program
A 15 minute soap opera episode

However, 5 minutes into the journey the context processor 215 can receive information that a traffic accident has occurred ahead resulting in the journey being extended to 40±5 minutes. In this case, the recommendation unit 207 can review the recommended list and can add an additional 10-15 minute program or can e.g. replace the soap opera with another program having a duration closer to the modified time window, i.e. having a duration closer to the remaining 30 minute of the time window. The user is then offered this option when the news program finishes.

It will be appreciated that the user equipment of FIG. 2 may enhance and simplify the mobile television user experience by providing improved recommendations of television programs. The approach seeks to allow users to benefit from an availability of a multitude of available content using an approach that is particularly advantageous for mobile content consumption and which in the specific example is closely aligned to the mobile viewing context.

It will be appreciated that although the previous description has focused on an embodiment wherein the functionality for generating the recommendations are located in a user equipment, the described principles apply equally to generation of recommendations in other locations. Specifically, some or all of the functionality for generating the recommendations may be implemented as part of the fixed section of the communication system. For example, rather than each individual user equipment comprising the functionality for generating recommendations, a centralised network-based recommendation server may be included in the fixed network to provide recommendations for a plurality of user equipments. Such a server may specifically comprise functionality similar to that described with reference to the user equipment of FIG. 2. In addition, the server and user equipments may comprise functionality for communicating requests for recommendations and the resulting recommendations between the server and the user equipments.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating content program recommendations, the method comprising:
providing characterising data for a plurality of content programs;
providing first context data for a user;
determining a content consumption time window for the user in response to the first context data; and
generating a content program recommendation comprising at least one content program of the plurality of content programs in response to the content consumption time window and the characterising data.

2. The method of claim 1 wherein the characterising data comprises a duration indication for each content program of the plurality of content programs; and the step of generating the content program recommendation comprises generating the content program recommendation in response to duration indications for the plurality of content programs.

3. The method of claim 1 wherein the content program recommendation provides content program recommendation for a duration corresponding to a duration of the content consumption time window.

4. The method of claim 1 wherein the content program recommendation comprises a content program playlist comprising a sequential list of content programs selected from the plurality of content programs.

5. The method of claim 4 wherein the step of generating the content program recommendation comprises generating the playlist in response to a content category preference value for a content category, the content category preference value for a content program belonging to the content category being dependent on a location of the content program in the playlist.

6. The method of claim 1 wherein the step of generating the content program recommendation comprises:
determining content preference values for each of the plurality of content programs in response to a user content preference profile; and
selecting the at least one content program for the content program recommendation in response to the content preference values.

7. The method of claim 6 wherein the step of selecting the at least one content program comprises determining preference values for at least a first content program in response to the content preference value for the first content program, a duration of the at least first content program and the content consumption time window.

8. The method of claim 6 wherein the step of determining content preference values comprises determining the content preference values in response to the context data.

9. The method of claim 8 wherein the step of determining content preference values comprises determining the content preference values in response to at least one of a current time and a current location for the user.

10. The method of claim 1 wherein the context data comprises a current time.

11. The method of claim 1 wherein the context data comprises a current location estimate for the user.

12. The method of claim 1 wherein the context data comprises appointment data for the user.

13. The method of claim 1 wherein the context data comprises traffic information data.

14. The method of claim 1 wherein the step of determining the content consumption time window comprises determining the content consumption time window in response to a previous content consumption behaviour of the user.

15. The method of claim 1 wherein the method further comprises:
determining content consumption characteristics and associated consumption context data for content consumptions by the user;
storing the content consumption characteristics and associated consumption context data;
retrieving a first content consumption characteristic associated with consumption context data matching the first context data; and wherein the step of determining the content consumption time window comprises determining the content consumption time window in response to the first content consumption characteristic.

16. The method of claim 15 wherein the associated consumption context data comprises at least one of consumption time data and location data.

17. The method of claim 1 wherein the method furthermore comprises:
determining second context data for the user during the content consumption time window;
updating the content program recommendation during the content consumption time window in response to the second context data.

18. The method of claim 1 wherein the plurality of content programs comprises real time broadcast programs.

19. An apparatus for generating content program recommendations, the apparatus comprising:
means for providing characterising data for a plurality of content programs;
means for providing first context data for a user;
means for determining a content consumption time window for the user in response to the first context data; and
means for generating a content program recommendation comprising at least one content program of the plurality of content programs in response to the content consumption time window and the characterising data.

20. A mobile terminal for a cellular communication system comprising:
means for providing characterising data for a plurality of content programs;
means for providing first context data for a user;
means for determining a content consumption time window for the user in response to the first context data; and
means for generating a content program recommendation comprising at least one content program of the plurality of content programs in response to the content consumption time window and the characterising data.
